(19) United States
(12) Patent Application Publication
(10) Pub. No.: US 2024/0412532 A1
(43) Pub. Date: Dec. 12, 2024

(54) APPARATUS AND METHOD FOR OBJECT AND STATE RECOGNITION IN A VEHICLE FRONT AREA

(71) Applicant: HELLA GmbH & Co. KGaA, Lippstadt (DE)

(72) Inventor: Florian KRIEFT, Sassenberg (DE)

(73) Assignee: HELLA GmbH & Co. KGaA, Lippstadt (DE)

(21) Appl. No.: 18/741,368

(22) Filed: Jun. 12, 2024

(30) Foreign Application Priority Data
Jun. 12, 2023 (DE) 10 2023 115 243.2

(51) Int. Cl. G06V 20/58; G06T 5/20; G06T 5/70; G06V 10/60

(52) U.S. Cl. CPC G06V 20/58; G06T 5/20; G06T 5/70; G06V 10/60; G06V 2201/07

(57) ABSTRACT

An apparatus for object and state recognition in a vehicle front area, including a headlamp for emitting light into the vehicle front area according to a predefined light distribution, including a camera for recording an image of the vehicle front area, including an image evaluation device for evaluating the image recorded by the camera. The image evaluation device having a smoothing routine, with the aid of which the captured image is smoothed as a raw image for the purpose of forming an intermediate image. A normalization routine with which the raw image and the intermediate image are normalized to a target image with the aid of a mathematical operation, so that the target image has normalized light intensity values, An image evaluation routine evaluates light intensity values of the target image for the purpose of recognizing a structuring and/or objects in the vehicle front area.

This nonprovisional application claims priority under 35 U.S.C. § 119(a) to German Patent Application No. 10 2023 115 243.2, which was filed in Germany on Jun. 12, 2023, and which is herein incorporated by reference.

### BACKGROUND OF THE INVENTION

### Field of the Invention

The invention relates to an apparatus for object and state recognition in a vehicle front area, including a headlamp for emitting light into the vehicle front area according to a predefined light distribution, including a camera for recording an image of the vehicle front area, including an image evaluation device for evaluating the image recorded by the camera.

The invention also relates to a method for object and state recognition in a vehicle front area, in which a headlamp generates a light distribution in the vehicle front area, and in which a camera records an image of the vehicle front area, the image captured by the camera being evaluated.

### Description of the Background Art

An apparatus for recognizing a state in a vehicle front area, which includes a LIDAR sensor, is known from DE 10 2016 210 379 A1, which corresponds to US 2019/0187286. The evaluation of the sensor signal provided by the LIDAR sensor results in a determination of the condition of the roadway surface.

An apparatus and a method for evaluating a headlamp state is known from EP 3 138 731 B1. The apparatus comprises a headlamp for emitting light into a vehicle front area, a camera for recording an image of the vehicle front area, as well as an image evaluation device for evaluating the image recorded by the camera. It is desirable to further increase the information content during the image evaluation.

### SUMMARY OF THE INVENTION

It is therefore an object of the present invention to refine an apparatus and a method for object and state detection in a vehicle front area in such a way that a capture quality of a radiation source is easily improved.

To achieve this object, the invention provides that the image evaluation device includes a smoothing routine, with the aid of which the captured image is smoothed as a raw image for forming an intermediate image; a normalization routine, with the aid of which the raw image and the intermediate image are normalized to a target image with the aid of a mathematical operation, so that the target image includes normalized light intensity values; an image evaluation routine, with the aid of which the light intensity values of the target image are evaluated for the purpose of detecting a structuring and/or objects in the vehicle front area.

The information content of the image is significantly increased by the image processing according to the invention, so that objects and/or state variables in the vehicle front area may be captured or recognized more reliably with the aid of a temporally subordinate algorithm. According to the invention, the raw image captured by the camera is smoothed and then normalized to a target image. Only the normalized target image is used for the evaluation or for the evaluation routine, which, compared to the raw image, allows structures to be recognized even in a far region of the vehicle front area or the light distribution. Light distributions emitted by a headlamp usually have the characteristic that the illumination intensities decrease as the distance from the vehicle increases, which means that the far region of the vehicle front area is illuminated less brightly that a near region of the vehicle front area. This disadvantage may be compensated for with the aid of the image processing or image evaluation according to the invention, so that structures may be recognized not only in the near field but also in the far field. The structures appear on the basis of differences in light intensity within the target image, which may be determined by suitable evaluation algorithms. In particular, the invention facilitates a better and more accurate recognition of objects in both the near region and in the far region of the vehicle front area. In particular, subjects or objects may be recognized which have a similar degree of reflection as the roadway in the vehicle front area. According to the invention, the image processing according to the invention permits a more precise extraction of a projected object or subject.

The smoothing routine can comprise a Gaussian smoothing filter, with the aid of which the raw image is blurred. The raw image is thus smoothed to eliminate any structures which may occur in the image.

The smoothed intermediate image can be normalized, image data or pixel data of the raw image being used for the normalization. A normalization of the light intensity values takes place hereby. The target image now calculated has a higher contrast compared to the raw image, in particular, in a far region of the recorded vehicle front area, so that structures of the target image may be evaluated more easily and more comprehensively.

The emitted light distribution may be designed as a line projection, which has a plurality of light bars running in the direction of travel or in the main emission direction of the headlamp. With the aid of the image processing or evaluation according to the invention, the light bars each run in a straight line and at a constant light intensity in both the near region and the far region of the image. The changes in angle of the light bars in relation to a standard bar or the further light bars may be advantageously ascertained depending on a pitch angle of the vehicle. The present pitch angle of the vehicle may be advantageously determined quickly and easily hereby.

The special advantage of the method according to the invention is that an image recorded by a camera is transformed based on software to the extent that a structuring within the image may be recognized based on differences in light intensity in a near region as well as in a far region of the recorded vehicle front area. The light distribution may be advantageously made more homogeneous by the image evaluation according to the invention. Light intensity values of the ascertained target image are distributed more evenly over a relatively large far and near region.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a block diagram of an apparatus according to the invention;

FIG. 2 shows a raw image of the vehicle front area, including a structure in a near field;

FIG. 3 shows an intermediate image of the vehicle front area calculated by smoothing the raw image;

FIG. 4 shows a normalized target image calculated from the intermediate image;

FIG. 5 shows a schematic representation of a line projection during the travel of a vehicle at a pitch angle=zero; and

FIG. 6 shows a representation of the line projection during the travel of the vehicle at a pitch angle of greater than zero.

### DETAILED DESCRIPTION

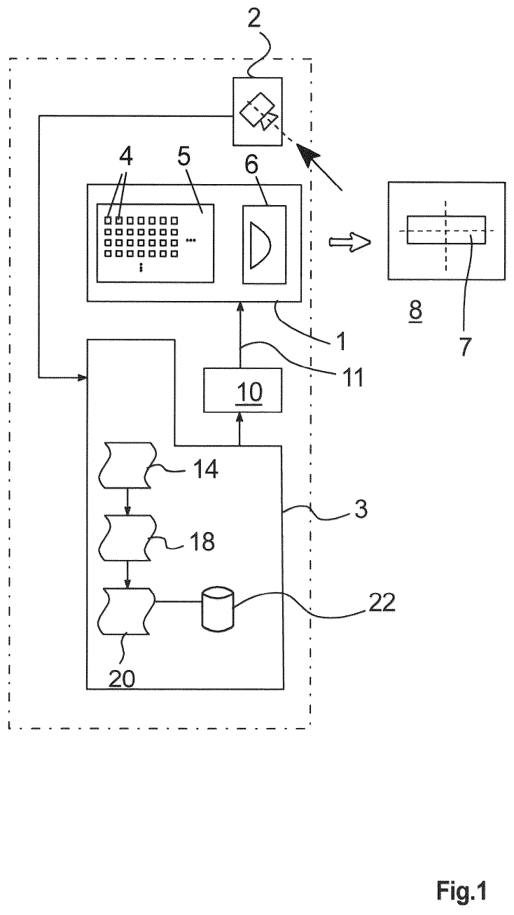

An apparatus according to the invention according to FIG. 1 essentially includes a headlamp 1, a camera 2, and an image evaluation device 3.

Headlamp 1 is designed as a high-resolution headlamp, which includes a plurality of individually controllable light sources 4, which are arranged on a carrier plate 5. Headlamp 1 further includes an optical unit 6 having a number of lenses, with the aid of which a predefined light distribution 7 is projected into a vehicle front area 8. Light sources 4 are preferably designed as LED light sources or LED pixels.

Camera 2 is preferably arranged in a region of a vehicle 9 near the roof, on a windshield thereof.

Image evaluation device 3 is a component of an evaluation unit, which includes a processor and a program memory, in which at least one evaluation program or evaluation algorithm is stored.

A control unit 10 is also provided for controlling light sources 4. Control signal 11 generated by control unit 10 for light sources 4 takes place depending on the type of object and state recognition in vehicle front area 8.

According to an example of the invention, control unit 10 generates a control signal 11 of this type in that headlamp 1 generates a rectangular light distribution 12 on a measuring screen. This may be, for example, an urban light distribution or a low beam distribution.

Camera 2 captures vehicle front area 8 and generates a recording of an image 13, which is provided to image evaluation device 3 as a raw image.

Image evaluation device 3 is software-based and has one or multiple algorithms, with the aid of which raw image 13 is further processed.

Image evaluation device 3 has a smoothing routine 14 as a mathematical operation, with the aid of which captured raw image 13 is smoothed, and an intermediate image 15 is generated according to FIG. 3.

Smoothing routine 14 comprises a Gaussian smoothing filter, with the aid of which pixel values of raw image 13 are weighted according to a two-dimensional discrete Gaussian function (bell curve) depending on its distance from a middle pixel. The Gaussian function is as follows:

$$b [ x , y ] = exp \frac{{x}^{2} + {y}^{2}}{2 {σ}^{2}} ,$$

where x, y are the coordinates, and sigma σ is a factor.

The following evaluation of the brightness values results for the middle pixel arranged in the following matrix:

$$\begin{matrix}1 & 4 & 6 & 4 & 1 \\ \begin{matrix}4 \\ 6 \\ 4 \\ 1\end{matrix} & [ \begin{matrix}16 \\ 24 \\ 16 \\ 4\end{matrix} ] & \begin{matrix}24 \\ 36 \\ 24 \\ 6\end{matrix} & \begin{matrix}16 \\ 24 \\ 16 \\ 4\end{matrix} & \begin{matrix}4 \\ 6 \\ 4 \\ 1\end{matrix}\end{matrix}$$

$$\frac{1}{256}$$

The 25 pixel values arranged in the filter matrix are not given equal weight but are weighted depending on their distance from the middle pixel.

The greater the value sigma σ, the greater is the smoothing. For example, sigma σ may take on the minimum value 8, preferably the value 18.

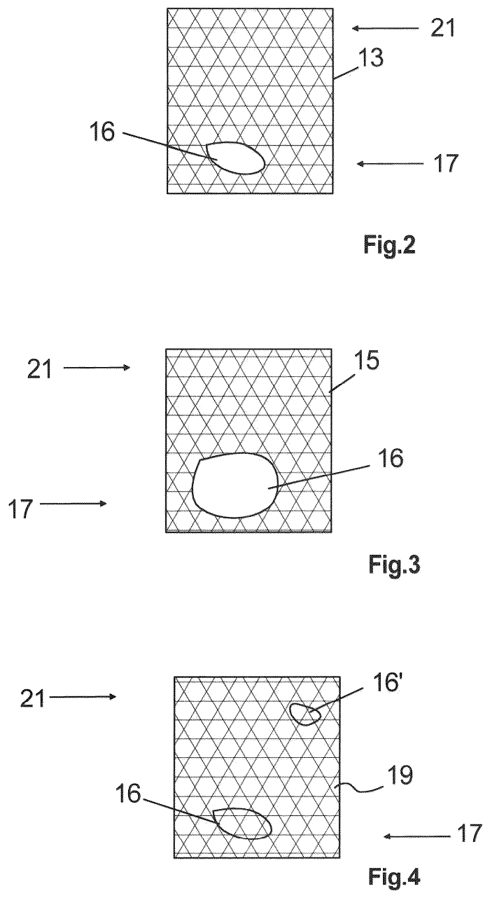

When evaluating raw image 13 according to FIG. 2, only one structuring 16 in a near region 17 of vehicle front area 8 may be ascertained, which may be recognized, for example, as a pothole. To also enable an analysis to be reliably carried out in a far region 21 of vehicle front area 8, raw image 13 is smoothed with the aid of the Gaussian filter matrix, so that intermediate image 15 results according to FIG. 3. It is apparent that structuring 16 is to be recognized as a large white spot, which has resulted due to the blurring. This intermediate image may not be used for the state or object recognition.

In a further step of the image evaluation, a normalization routine 18 is now applied, with the aid of which a target image 19 according to FIG. 4 is generated from intermediate image 15, which forms the basis for a final structure evaluation by an image evaluation routine 20.

In the present example, normalization routine 18 is formed in such a way that a quotient is calculated from the brightness values of raw image 13 and intermediate image 15, as follows:

$$\frac{pixel values of raw image 17 [ sic ; 13 ]}{pixel values of intermediate image 15} = pixel values of the target image 19$$

It is apparent from FIG. 4 that target image 19 has not only structuring 16 in near region 17 but also a structuring 16′ in far region 21 of vehicle front area 8. By applying image evaluation routine 20 to target image 19, pothole 16 in near region 17 as well as pothole 16′ in far region 21 may now be recognized, while only pothole 16 in near region 17 of vehicle front area 8 would be recognized in the evaluation of raw image 13. With the aid of the invention, dark regions in far region 21 (a long distance away), which undergoes a more limited illumination, may be compared with each other by the normalization in terms of their intensity values and bright regions in near region 17. A more uniform target image 19 compared to raw image 13 is obtained thereby, which results in a better ability to recognize objects in far region 21.

Structuring 16′ in far region 21 may be identified based on higher light intensity differences or a higher contrast in far region 21. A “transfer” of the light from near region 17 to far region 21 of vehicle front area 8 or the image takes place with the aid of the smoothing and normalization algorithm according to the invention, so that structurings in far region 21 may also be recognized.

Additionally or alternatively, target image 19 in near region 17 of vehicle front area 8 may have a higher contract compared to near region 17 of raw image 13, so that an object situated in near region 17 may be better recognized.

The evaluation program containing smoothing routine 14, normalization routine 18, and image evaluation routine 20 is stored in a memory 22 of image evaluation device 3. Image evaluation device 3 may have, for example, reference image data or comparison data stored in memory 22, which may be accessed by image evaluation routine 20. The state or structuring 16, 16′ in vehicle front area 8 may be ascertained by comparing the target image with a predefined reference image or reference data. A comparison between target image 19 and the reference image preferably takes place.

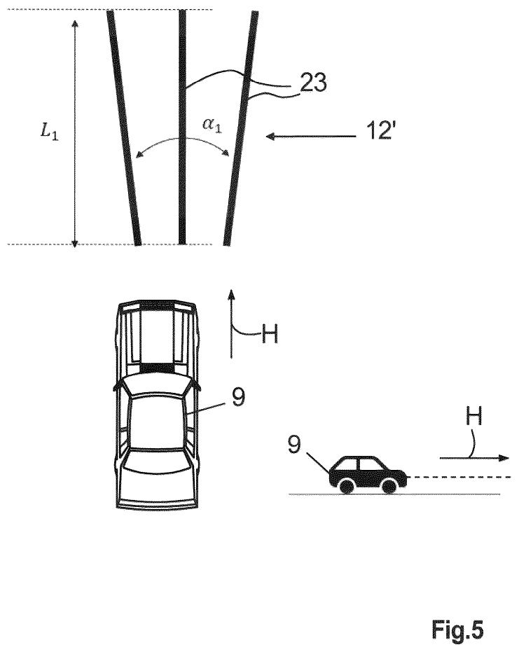

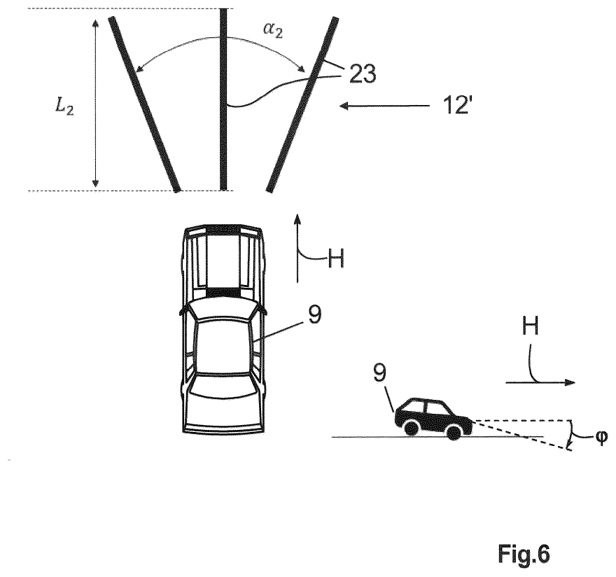

According to an example of the invention according to FIGS. 5 and 6, control unit 10 may generate a control signal 11 such that light sources 4 in connection with optical unit 6 generates a light distribution 12′ in the form of line projections or line bars 23, which run in main emission direction H of headlamp 1, i.e., in the vehicle longitudinal direction or direction of travel. If vehicle 9 is in a horizontal position according to FIG. 5, light bars 23 have a length L1, and outer light bars 23 enclose an opening angle α1. Pitch angle φ of vehicle 9 is 0°.

If, for example, vehicle 9 brakes, resulting in a pitch angle φ greater than 0°, cf. FIG. 6, light bars 23 spread apart and have a reduced length L2, and opening angle α2 is greater than opening angle α1 in the horizontal position of vehicle 9. Due to the image evaluation according to the invention, with the aid of a smoothing and normalization of light bars 23, changing opening angle α2 may be reliably recognized compared to original opening angle α1, and current pitch angle φ of the vehicle may be determined based on a dependency rule.

The image evaluation according to the invention thus permits a state recognition of vehicle 9 or of vehicle front area 8. The image evaluation may also be used for the improved recognition of objects, such as pedestrians, signs, etc., in vehicle front area 8.

According to an example of the invention, infrared radiation sources or radiation sources of other wave ranges may also be used instead of LED light sources 4.

For example, a roadway covering in the form of snow, rain, or moisture may be recognized as structuring with the aid of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An apparatus for object and state recognition in a vehicle front area, the apparatus comprising:
a headlamp to emit light towards a vehicle front area according to a predefined light distribution;
a camera to record an image of the vehicle front area;
an image evaluation device to evaluate the image recorded by the camera, the image evaluation device comprising:
a smoothing routine, via which the captured image is smoothed as a raw image for forming an intermediate image;
a normalization routine, via which the raw image and the intermediate image are normalized to a target image using a mathematical operation, so that the target image has normalized light intensity values; and
an image evaluation routine, via which the light intensity values of the target image are evaluated to recognize a structuring and/or objects in the vehicle front area.

2. The apparatus according to claim 1, wherein the smoothing routine and the normalization routine and the image evaluation routine are designed to be software-based.

3. The apparatus according to claim 1, wherein the smoothing routine comprises a Gaussian smoothing filter, with the aid of which pixel values of the raw image are weighted according to a two-dimensional discrete Gaussian function depending on its distance from a middle pixel.

4. The apparatus according to claim 1, wherein the normalization routine is designed in such a way that a quotient is calculated pixel by pixel from the raw image and the intermediate image, and wherein the pixels of the calculated quotient form the target image.

5. The apparatus according to claim 1, wherein the σ of the Gaussian smoothing formula is at least 8.

6. The apparatus according to claim 1, wherein, in a near region and/or far region of the vehicle front area, the target image has a higher contrast compared to the near region or the far region of the raw image so that an object situated in the near region and/or the far region and/or a roadway condition feature is recognizable by evaluating the target image.

7. The apparatus according to claim 1, wherein the roadway condition feature is recognizable as a pothole and/or as a roadway covering in the form or snow, rain, or moisture and/or as an object.

8. The apparatus according to claim 1, wherein the line projection comprises a plurality of light bars running in a direction of travel and/or in the main emission direction, whose angles change in relation to each other depending on a pitch angle of the vehicle running in relation to a horizontal plane.

9. The apparatus according to claim 1, wherein the headlamp is a high-resolution headlamp.

10. A method for object and state recognition in a vehicle front area, in which a headlamp generates a light distribution in the vehicle front area, and in which a camera records an image of the vehicle front area, the image captured by the camera being evaluated, the method comprising:
smoothing the captured image as a raw image to an intermediate image with the aid of a mathematical operation;
calculating a normalized target image from the raw image and the intermediate image with the aid of a mathematical operation; and
evaluating the target image with respect to brightness differences for recognizing a structuring or an object in the target image.

11. The method according to claim 10, wherein the raw image is converted into the intermediate image with the aid of a Gaussian filtering.

12. The method according to claim 10, wherein the target image is calculated by computationally dividing the raw image of the brightness values of the pixels of the raw image, by the brightness values of the pixels of the intermediate image, and wherein the pixel values of the target image alone are evaluated.

13. The method according to claim 10, wherein the target image is checked for the presence of light intensity differences in regions or in pixels, so that roadway condition structures may be derived therefrom.

14. The method according to claim 10, wherein the target image is compared with a reference image or with a reference value, so that structure particles determining a visual range are recognized.
